(19) United States
(12) Patent Application Publication
(10) Pub. No.: US 2014/0093858 A1
(43) Pub. Date: Apr. 3, 2014

(54) METHOD AND SYSTEM FOR EVALUATING ELECTRONIC DOCUMENT

(71) Applicants: Edward B. Caruthers, JR., Rochester, NY (US); Roger A. Newell, Pittsford, NY (US); Robert M. Lofthus, Webster, NY (US); Kristine A. German, Webster, NY (US); Dennis L. Venable, Marion, NY (US)

(72) Inventors: Edward B. Caruthers, JR., Rochester, NY (US); Roger A. Newell, Pittsford, NY (US); Robert M. Lofthus, Webster, NY (US); Kristine A. German, Webster, NY (US); Dennis L. Venable, Marion, NY (US)

(73) Assignee: XEROX CORPORATION, Norwalk, CT (US)

(21) Appl. No.: 13/632,363

(22) Filed: Oct. 1, 2012

(51) Int. Cl. G09B 7/00

(52) U.S. Cl. 434/362

(57) ABSTRACT

The disclosed embodiment relates to methods and systems for evaluating an electronic document. The computer implemented method includes receiving the electronic document containing a first set of answers corresponding to one or more pre-stored questions. The first set of answers are compared with a pre-stored second set of answers based on an answer descriptor syntax dataset. The answer descriptor syntax dataset comprises one or more rules. One or more answer descriptors for each of the first set of answers are determined based on the comparing. The one or more answer descriptors correspond to one or more observations for each of the first set of answers. Finally, the electronic document is evaluated based on determining.

### TECHNICAL FIELD

The presently disclosed embodiments are related to an evaluation system. More specifically, the presently disclosed embodiments are related to an evaluation system for evaluating an electronic document.

### BACKGROUND

Evaluators in an institution manually evaluate answer documents filled by one or more evaluatees. Based on the evaluation, the evaluators grade the one or more evaluatees. Recent advancements in the field of image processing, have led to development of an automated evaluation system. Such a system includes a scanner that scans one or more answer documents filled by one or more evaluatees. The evaluation system compares the answers in each of the one or more answer documents with a set of correct answers to grade the one or more answer documents. Evaluators may analyze the one or more graded answer documents to formulate a progress report for each of the one or more evaluatees. However, while analyzing, evaluators may face a difficulty in determining a reason for which an evaluatee has marked an incorrect answer in the answer document.

### SUMMARY

According to embodiments illustrated herein, there is provided a computer-implemented method for generating an evaluation model. The method includes generating a question data set comprising one or more questions. The method further includes generating an answer descriptor syntax data set comprising one or more rules to generate one or more answer descriptors. The one or more answer descriptors correspond to one or more observations based on each of the one or more answers. Furthermore, the method includes generating an answer descriptor data set comprising one or more answer descriptors. The one or more answer descriptors correspond to one or more observations based on each of the one or more answers. Thereafter, a question descriptor data set is generated. The question descriptor data set corresponds to characteristics of one or more elements in the one or more questions. Finally, the method includes generating an evaluation model based on the answer descriptor data set.

According to embodiments illustrated herein, there is provided a computer-implemented method for evaluating an electronic document. The computer-implemented method includes receiving the electronic document containing a first set of answers corresponding to one or more pre-stored questions. The first set of answers is compared with a pre-stored second set of answers. The comparison is performed based on an answer descriptor syntax dataset. The answer descriptor syntax data set comprises one or more rules. The method further includes determining one or more answer descriptors for each of the first set of answers based on the comparing. The one or more answer descriptors correspond to one or more observations for each of the first set of answers. Finally, the method includes evaluating the electronic document based on the determining.

According to embodiments illustrated herein, there is provided a system for generating an evaluation model. The system includes a question data set generation module configured to generate a question data set comprising one or more questions. An answer data set generation module is configured to generate an answer data set comprising one or more answers. The one or more answers correspond to each of the one or more questions. A descriptor syntax module configured to generate an answer descriptor syntax data set comprising one or more rules to generate one or more answer descriptors. The one or more answer descriptors correspond to one or more observations based on each of the one or more answers. An evaluator module configured to generate an evaluation model is based on the answer descriptor syntax data set.

According to embodiments illustrated herein, there is provided a system for evaluating an electronic document. The system includes a comparison module configured to compare a first set of answers in the electronic document with a pre-stored second set of answers based on an answer descriptor syntax dataset. The answer descriptor syntax data set comprises one or more rules. The comparison module is further configured to determine, one or more answer descriptors for each of the first set of answers based on the comparing. The one or more answer descriptors correspond to one or more observations for each of the first set of answers. An evaluator module is configured to evaluate the electronic document, based on the one or more answer descriptors.

### BRIEF DESCRIPTION OF DRAWINGS

The accompanying drawings illustrate various embodiments of systems, methods, and embodiments of various other aspects of the disclosure. Any person having ordinary skills in the art will appreciate that the illustrated element boundaries (e.g., boxes, groups of boxes, or other shapes) in the figures represent one example of the boundaries. It may be that in some examples, one element may be designed as multiple elements or that multiple elements may be designed as one element. In some examples, an element shown as an internal component of one element may be implemented as an external component in another, and vice versa. Furthermore, elements may not be drawn to scale.

Various embodiments will hereinafter be described in accordance with the appended drawings, which are provided to illustrate, and not to limit, the scope in any manner, wherein like designations denote similar elements, and in which:

FIG. 1 is a block diagram illustrating a system environment, in which, various embodiments can be implemented;

FIG. 2 is a block diagram illustrating an evaluation system in accordance with at least one embodiment;

FIG. 3 is a data structure illustrating answer descriptor syntax in accordance with at least one embodiment;

FIG. 4 is a flowchart illustrating a method for generating an evaluation model in accordance with at least one embodiment; and

FIG. 5 is another flowchart illustrating a method for evaluating one or more electronic documents in accordance with at least one embodiment.

### DETAILED DESCRIPTION

The present disclosure is best understood with reference to the detailed figures and description set forth herein. Various embodiments are discussed below with reference to the figures. However, those skilled in the art will readily appreciate that the detailed descriptions given herein with respect to the figures are simply for explanatory purposes as methods and systems may extend beyond the described embodiments. For example, the teachings presented and the needs of a particular application may yield multiple alternate and suitable approaches to implement the functionality of any detail described herein. Therefore, any approach may extend beyond the particular implementation choices in the following embodiments described and shown.

References to “one embodiment”, “an embodiment”, “one example”, “an example”, “for example” and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

Definitions: The following terms shall have, for the purposes of this application, the respective meanings set forth below.

An “evaluation model” refers to a statistical model that evaluates one or more answer sheets written by one or more students. In an embodiment, the evaluation model grades each of the one or more answer sheets. Accordingly, the evaluation model generates a progress report for each of the one or more students. Further, the evaluation model provides observations on each answer in each of the one or more answer sheet.

A “question” refers to a linguistic expression used to make a request for information. In an embodiment, questions include interrogative sentences. Some examples of the questions may include, but are not limited to, Multiple Choice Questions (MCQs), fill in the blanks, and the like.

An “answer” refers to a response to a question.

“Answer sheets” refer to documents that include answers to the questions. Some of the examples of the answer sheet may include, but not limited to, Optical mark recognition (OMR) sheet, handwriting recognition answer sheets, matching connector answer sheets, and the like.

“Answer descriptors syntax” refers to a set of rules for analyzing and drawing an observation on an answer provided. In an embodiment, the answer descriptor syntax includes one or more ‘if’ and ‘else’ statements that are utilized for drawing the observation. In an alternate embodiment, the answer descriptor syntax includes one or more scripting language rules that may be user for drawing conclusion on one or more complex question. For example, a question “4+3” is provided. Following may be a set of answer descriptor syntax for the question “4+3”:

If answer = “7”, then observation = “correct”;
If answer = “1”, then observation = “operator misinterpretation: Answer
provided for 4 − 3 instead of 4 + 3”;
If answer = “12”, then observation = “operator misinterpretation: Answer
provided for 4 * 3 instead of 4 + 3”.

In an embodiment, the observation drawn by using the answer descriptor syntax corresponds to an answer descriptor.

Question descriptor refers to metadata associated with one or more questions. In an embodiment, the metadata includes type of questions, possible misinterpretation for each of the one or more questions, one or more elements in a question, etc.

A Multi Function Device (MFD) refers to a device that can perform multiple functions. Examples of the functions include, but are not limited to, printing, scanning, copying, faxing, emailing, and the like. In an embodiment, the MFD includes a scanner and a printer for scanning and printing one or more documents respectively. In an embodiment, the MFD has communication capabilities that enable the MFD to send/receive data and messages in accordance with one or more communication protocols such as, but not limited to, FTP, WebDAV, E-Mail, SMB, NFS, and TWAIN.

A Print refers to an image on a medium (such as paper), that is capable of being read directly through human eyes, perhaps with magnification. According to this disclosure, a handwritten or partially handwritten image on a medium is considered as an original print. In an embodiment, a duplicate print corresponds to an exact replica of the original print derived by scanning, printing or both.

A Printer refers to any apparatus, such as a digital copier, bookmaking machine, facsimile machine, multi-function machine (performing scanning, emailing), and the like, which performs a print (original and/or duplicate) outputting function for any purpose in response to digital data sent thereto.

An Image file refers to a collection of data, including image data in any format, retained in an electronic form.

Scanning refers to recording an image on a print as digital data in any format, thereby creating an image file.

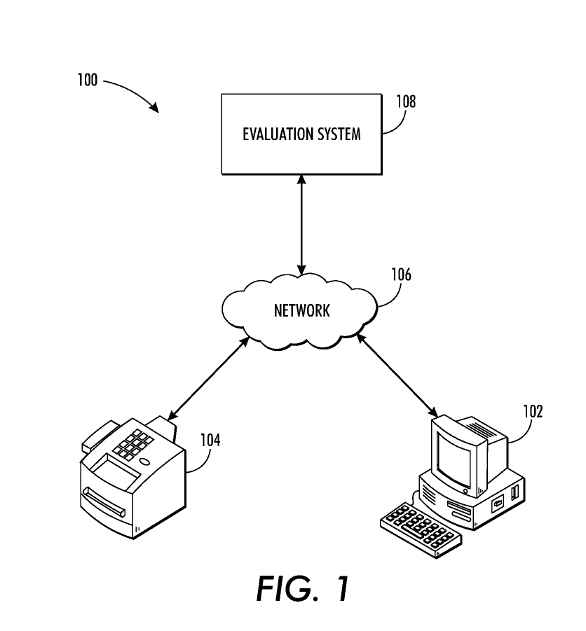

FIG. 1 is a block diagram illustrating a system environment 100, in which various embodiments can be implemented. The system environment 100 includes a computing device 102, an MFD 104, a network 106, and an evaluation system 108.

The computing device 102 receives a user input to perform one or more operations such as, but not limited to, creating one or more questions, scanning one or more answer sheets through the MFD 104, defining one or more answer descriptor syntaxes, defining one or more question descriptor for each of the one or more questions, and printing one or more evaluated answer sheets using the MFD 104. Some of the examples of the computing device 102 include a personal computer, a laptop, a PDA, a mobile device, a tablet, or any device that has the capability to receive user input to perform the one or more operations.

The network 106 corresponds to a medium through which the content and the messages flow between various components (e.g., the computing device 102, the MFD 104, and the evaluation system 108) of the system environment 100. Examples of the network 106 may include, but are not limited to, a Wireless Fidelity (WiFi) network, a Wireless Area Network (WAN), a Local Area Network (LAN) or a Metropolitan Area Network (MAN). Various devices in the system environment 100 can connect to the network 106 in accordance with various wired and wireless communication protocols such as Transmission Control Protocol and Internet Protocol (TCP/IP), User Datagram Protocol (UDP), 2G, 3G or 4G communication protocols.

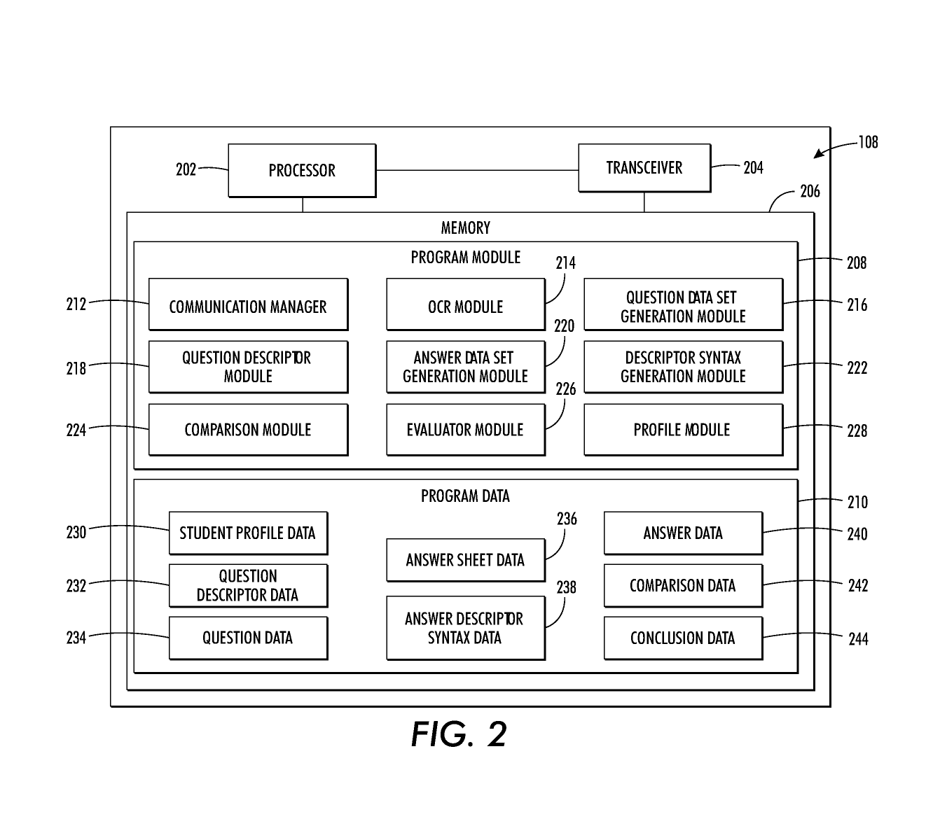

The evaluation system 108 is a computing device that includes an evaluation model. The evaluation system 108 receives one or more scanned answer sheets from the MFD 104. In an embodiment, the evaluation system 108 receives one or more question descriptors and one or more answer descriptor syntaxes from the computing device 102. In an alternate embodiment, the evaluation system 108 analyzes the one or more scanned answer sheet and one or more questions to generate the one or more answers descriptor syntaxes and the one or more question descriptors. The evaluation system 108 is described in conjunction with FIG. 2.

A person ordinary skilled in the art would appreciate that the scope of the disclosure should not be limited to the evaluation system 108 as a separate system. In an embodiment, the evaluation system 108 is implemented on the MFD 104. In another embodiment, the evaluation system 108 is implemented on the computing device 102.

FIG. 2 is a block diagram illustrating the evaluation system 108 in accordance with at least one embodiment. The evaluation system 108 includes a processor 202, a transceiver 204, and memory 206.

The processor 202 is coupled to the transceiver 204, and the memory 206. The processor 202 executes a set of instructions stored in the memory 206. The processor 202 can be realized through a number of processor technologies known in the art. Examples of the processor 202 can be, but are not limited to, X86 processor, RISC processor, ASIC processor, CISC processor, or any other processor.

The transceiver 204 transmits and receives messages and data to/from the various components (e.g., the computing device 102, and the MFD 104) of the system environment 100 (refer FIG. 1). Examples of the transceiver 204 can include, but are not limited to, an antenna, an Ethernet port, a USB port or any port that can be configured to receive and transmit data from an external source. The transceiver 204 transmits and receives data/messages in accordance with various communication protocols, such as, Transmission Control Protocol and Internet Protocol (TCP/IP), User Datagram Protocol (UDP), 2G, 3G and 4G communication protocols.

The memory 206 stores a set of instructions and data. Some of the commonly known memory implementations can be, but are not limited to, random access memory (RAM), read only memory (ROM), hard disk drive (HDD), and secure digital (SD) card. The memory 206 includes a program module 208 and a program data 210. The program module 208 includes a set of instructions that can be executed by the processor 202 to perform one or more operations on the evaluation system 108. The program module 208 includes a communication manager 212, an Optical Character Recognition (OCR) module 214, a question data set generation module 216, a question descriptor module 218, an answer data set generation module 220, a descriptor syntax generation module 222, a comparison module 224, an evaluator module 226, and a profile module 228. Although, various modules in the program module 208 have been shown in separate blocks, it may be appreciated that one or more of the modules may be implemented as an integrated module performing the combined functions of the constituent modules.

The program data 210 includes a student profile data 230, a question descriptor data 232, a question data 234, an answer sheet data 236, an answer descriptor syntax data 238, an answer data 240, a comparison data 242, and a conclusion data 244.

The communication manager 212 receives one or more scanned answers sheets from the MFD 104 through the transceiver 204. In an embodiment, the communication manager 212 includes various protocol stacks such as, but not limited to, Transmission Control Protocol and Internet Protocol (TCP/IP), User Datagram Protocol (UDP), 2G, 3G or 4G communication protocols. The communication manager 212 transmits and receives the messages/data through the transceiver 204 in accordance with such protocol stacks. Further, the communication manager 212 stores the one or more scanned answer sheets as the answer sheet data 236.

The OCR module 214 recognizes one or more words or characters in each of the one or more scanned answer sheets. Thereafter, the OCR module 214 stores the one or more recognized answer sheets as the answer sheet data 236. In an embodiment, the OCR module 214 recognizes the one or more characters based on the type of answer sheet. For example, if the answer sheet is an OMR sheet, the OCR module detects one or more marks or bubbles filled by the child on the answer sheet.

The question data set generation module 216 receives one or more questions from the computing device 102 through the transceiver 204. In an embodiment, the one or more questions received from the computing device 102 correspond to a first set of answers in each of the one or more scanned answer sheets. In an alternate embodiment, the question data set generation module 216 receives one or more scanned question documents from the MFD 104. The OCR module 214 recognizes the one or more characters/words in the one or more question documents to determine the one or more questions. The question data set generation module 216 stores the one or more questions as the question data 234.

The question descriptor module 218 extracts the one or more questions from the question data 234. Thereafter, the question descriptor module 218 determines metadata associated with each of the one or more questions. In an embodiment, the metadata includes, but is not limited to, type of question, possible misinterpretations for each of the one or more questions, one or more elements in a question, etc. In an embodiment, the question descriptor module 218 includes a parser tool to determine the metadata. In an embodiment, the question descriptor module 218 receives the metadata for each of the one or more questions from the computing device 102. The question descriptor module 218 stores the metadata as the question descriptor data 232.

The answer data set generation module 220 generates a second set of answers for each of the one or more questions that have been stored as the question data 234. In an embodiment, the second set of answers includes one or more correct answers for the one or more questions. In an embodiment, the answer data set generation module 220 generates the second set of answers based on the question descriptor data 232. In an embodiment, the answer data set generation module 220 receives the second set of answers from the computing device 102. The answer data set generation module 220 stores the second set of answers as the answer data 240.

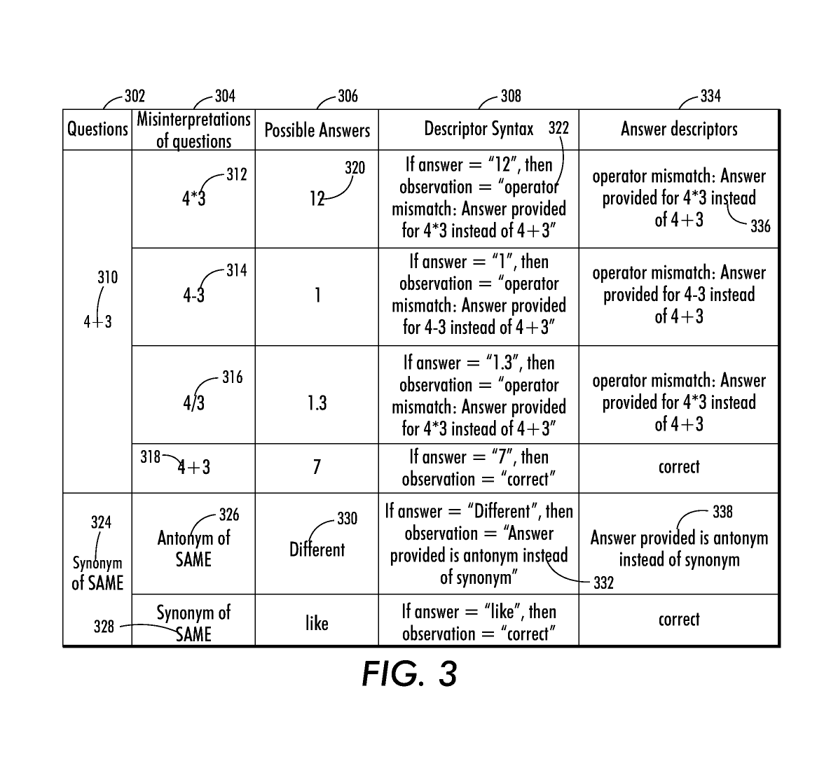

The descriptor syntax generation module 222 extracts the metadata associated with each of the one or more questions from the question descriptor data 232. Based on the metadata, the descriptor syntax generation module 222 determines one or more answer descriptor syntaxes for each of the one or more questions. For example, the descriptor syntax generation module 222 determines possible misinterpretations of each of the one or more questions from the metadata. Thereafter, the descriptor syntax generation module 222 determines answers for each of the possible misinterpretations of each of the one or more questions. Based on the answers for each of the possible misinterpreted questions, the descriptor syntax generation module 222 generates the one or more answer descriptor syntaxes. In an embodiment, descriptor syntax generation module 222 receives the one or more answer descriptor syntaxes for each of the one or more questions from the computing device 102. Further, the descriptor syntax generation module 222 stores the one or more answer descriptor syntaxes as the answer descriptor syntax data 238. The answer descriptor syntax data 238 is described later in conjunction with FIG. 3.

The comparison module 224 extracts the second set of answers from the answer data 240. Thereafter, the comparison module 224 compares the first set of answers in of the one or more answer sheets with the second set of answers. In an embodiment, the comparison module 224 compares the first set of answers and the second set of answer by applying one or more rules in the answer descriptor syntax data 238. The comparison module 224 determines one or more correct answers and one or more incorrect answers from the first set of answers based on the comparison. The comparison module 224 stores the compared answer sheet as the comparison data 242.

The evaluator module 226 extracts the one or more compared answer sheets from the comparison data 242. The evaluator module 226 analyzes the one or more correct answers, the one or more incorrect answers to determine one or more answer descriptors for each of the first set of answers. In an embodiment, the evaluator module 226 applies one or more answer descriptor syntaxes in the answer descriptor syntax data 238 to determine the answer descriptors. Further, the evaluator module 226, analyzes the one or more answer descriptors for each of the first set of answers to draw a conclusion about the types of mistakes that a student has committed. The evaluator module 226 stores the conclusion for each of the one or more scanned answer sheets as the conclusion data 244. The evaluator module 226 can be realized through various known classification technologies such as, but not limited to, if-then-else rules, fuzzy logic and neural networks.

The profile module 228 generates/updates a student profile of a student associated with at least one of the one or more scanned answer sheets. In an embodiment, the student profile includes, but is not limited to, student's name, student's roll number, progress report of a student, etc. The profile module 228 extracts the conclusion on each of the one or more scanned answer sheets from the conclusion data 244. Based on the conclusion, the profile module 228 updates the student profile. The profile module 228 stores the student profile for each of the one or more students as the student profile data 230.

FIG. 3 is a data structure 300 illustrating the answer descriptor syntax data 238 in accordance with at least one embodiment. The data structure 300 is described in conjunction with FIG. 1.

The data structure 300 includes a column 302 illustrating one or more questions (refer FIG. 1). For example, the one or more questions includes a first question, “4+3” (depicted by 310) and a second question “what is synonym of SAME?” (depicted by 324). Further, the data structure 300 includes a column 304 illustrating various misinterpretations of the questions depicted in column 302. For example, the first question “4+3” (depicted by 310) can be misinterpreted as “4*3” (depicted by 312), “4−3” (depicted by 314), and “4/3” (depicted by 316). The data structure 300 includes column 306 illustrating possible answers for each of the possible misinterpretation of the question depicted in column 304. For example, possible answer for “4*3” (depicted by 306) is “12” (depicted by 320). Further, the data structure 300 includes column 308 illustrating descriptor syntax for each of possible answers in column 306. For example, descriptor syntax for the possible answer “12” (depicted by 320) is “if answer=12, then observation=operator misinterpretation: Answer provided for 4*3 instead of 4+3” (depicted by 322). In an embodiment, rules in the descriptor syntax (depicted by 308) column can be a nested if-else statement which when executed draws an observation about the answer in the answer sheet. For example, “if answer=12, then observation=operator misinterpretation: Answer provided for 4*3 instead of 4+3; else if answer=“1”, then observation=“operator mismatch: Answer provided for 4−3 instead of 4+3”. Finally, the data structure 300 includes column 334 that includes answer descriptors determined by executing the descriptor syntax in column 308. For example, if the descriptor syntax 332 is satisfied, then the observation “operator misinterpretation: Answer provided for 4*3 instead of 4+3” (depicted by 336) is drawn.

Similarly, for the second question “what is synonym of SAME?” (depicted by 324) possible misinterpretations of the second question include “what is antonym of SAME?” (depicted by 326). Further, possible answer for “what is antonym of SAME?” (depicted by 326) is “different” (depicted by 330).

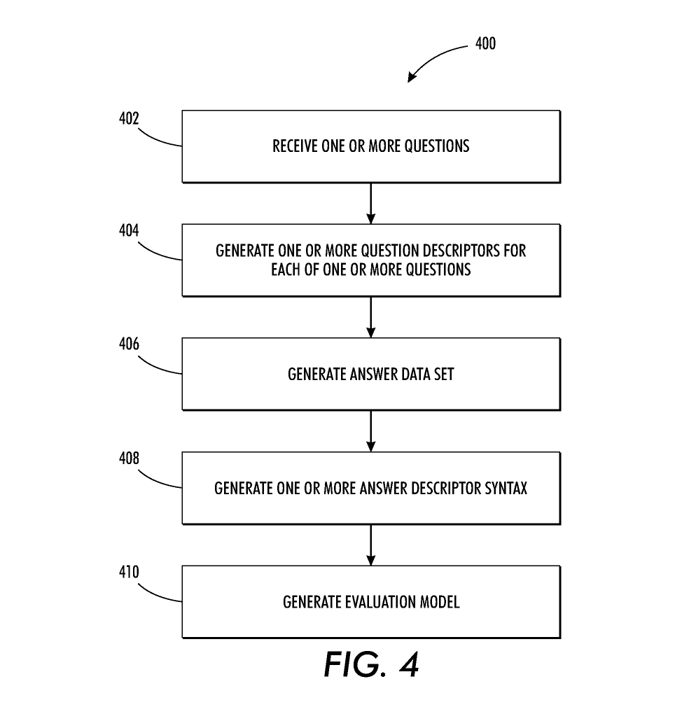

FIG. 4 is a flowchart 400 illustrating a method for generating an evaluation model in accordance with at least one embodiment. The flowchart 400 is described in conjunction with FIG. 1, FIG. 2 and FIG. 3.

At step 402, one or more questions are received from the computing device 102 (refer FIG. 1). In an embodiment, the question data set generation module 216 receives the one or more questions from the computing device 102. In an embodiment, the question data set generation module 216 receives one or more scanned question sheets that include the one or more questions. The OCR module 214 recognizes the one or more questions in the one or more scanned question sheets. Further, the question data set generation module 216 stores the one or more questions as the question data 234.

At step 404, one or more questions descriptors for each of the one or more questions are generated. In an embodiment, the question descriptor module 218 generates the one or more questions descriptors. The question descriptor module 218 analyzes the one or more questions to determine metadata for each of the one or more questions. For example, the one or more questions includes a question that states “4+3=______”. The question descriptor module 218 determines one or more elements in the question i.e. “4”, “+”, and “3”. In an embodiment, the one or more elements for a mathematical question are determined using one or more parsing techniques. In an embodiment, the question descriptor module 218 determines that “+” operator can be misinterpreted as “−”, “÷”, or “×”. The question descriptor module 218 stores the possible misinterpretation of the question as the question descriptor data 232. Thereafter, the descriptor syntax generation module 222 computes answers for misinterpreted questions (e.g., “4−3”, “4÷3”, and “4×3”). The descriptor syntax generation module 222 stores the answers for each of the possible misinterpreted questions in the data structure 300 (refer FIG. 3).

In another example, one or more questions include a question “what is synonym of SAME”. The question descriptor module 218 determines one or more elements in the questions, i.e., “synonym” and “SAME”. In an embodiment, the one or more elements for linguistic questions are determined by determining part of speech in the linguistic question. Thereafter, the question descriptor module 218 determines that “synonym” can be misinterpreted as “antonym”. The descriptor syntax generation module 222 determines answers for possible misinterpreted question (e.g., “what is antonym of SAME”).

In an alternate embodiment, the question descriptor module 218 receives the metadata from the computing device 102. A subject matter expert defines the metadata for each of the one or more questions using the computing device 102. Further, the subject matter expert provides answers to the one or more questions and the possible misinterpretation of the one or more question.

At step 406, a second set of answers for each of the one or more questions is computed. In an embodiment, the answer data set generation module 220 computes the second set of answers. The answer data set generation module 220 extracts the metadata for each of the one or more questions from the question descriptor data 232. The answer data set generation module 220 analyzes the metadata to determine the second set of answers. For example, the answer data set generation module 220 analyzes the metadata to determine one or more elements in a question. Thereafter, based on the one or more elements, the answer data set generation module 220 generates an answer for the question. For instance, the one or more elements include “4”, “3”, and “+”. From the one or more elements, the answer data set generation module 220 determines that the question corresponds to the addition of digits “4” and “3”. Thus, the answer data set generation module 220 computes the mathematical expression to generate an answer “7”. In another example, the answer data set generation module 220 determines the metadata of a second question “what is synonym of SAME”. From the metadata, the answer data set generation module 220 determines that the one or more elements of the second question include “synonym” and “SAME”. From the one or more elements, the answer data set generation module 220 determines that the question corresponds to finding a synonym of the word “SAME”. Thereafter, the answer data set generation module 220 determines a synonym of “SAME” from an internal dictionary or web-based dictionary. Further, the answer data set generation module 220 stores the second set of answers as the answer data 240.

In an alternate embodiment, the answer data set generation module 220 receives the second set of answers from the computing device 102. A subject matter expert defines the second set of answers for each of the one or more questions using the computing device 102.

At step 408, one or more answer descriptor syntaxes are generated for each of the one or more questions. In an embodiment, the descriptor syntax generation module 222 generates the one or more answer descriptor syntaxes. The descriptor syntax generation module 222 extracts the metadata for each of the one or more questions from the question descriptor data 232. Based on the metadata, the descriptor syntax generation module 222 generates the one or more answer descriptor syntaxes. For example, from the metadata, the descriptor syntax generation module 222 determines one or more possible misinterpretations for each of the one or more questions. Further, the descriptor syntax generation module 222 extracts the answers for each of the possible misinterpretations for each of the one or more questions from the data structure 300. Based on the answers of the one or more misinterpreted questions and the one or more misinterpreted questions, the descriptor syntax generation module 222 generates the one or more answer descriptor syntaxes. For instance, for a question “4+3”, the misinterpreted questions include “4−3”, “4÷3”, and “4×3”. Further, the answers for the misinterpreted questions “4−3”, “4÷3”, and “4×3” include “1”, “1.3”, and “12” respectively. Example of an answer descriptor syntax for the misinterpreted questions “4−3” may include “If answer=“1”, then observation=“operator misinterpretation: Answer provided for 4−3 instead of 4+3”. The descriptor syntax generation module 222 stores the one or more answer descriptor syntaxes as the answer descriptor syntax data 238.

At step 410, an evaluation model is generated based on the answer descriptor syntax data 238, question descriptor data 232, the answer data 240. In an embodiment, the evaluator module 226 generates the evaluation model.

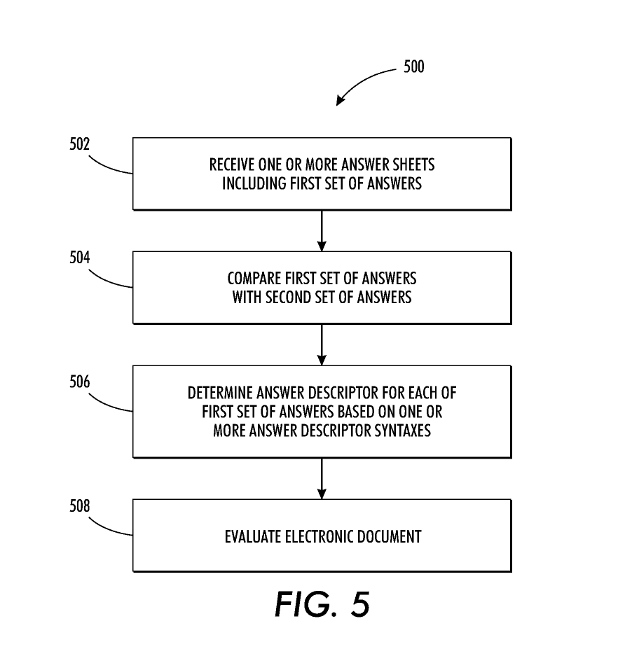

FIG. 5 is a flowchart 500 illustrating a method for evaluating one or more electronic documents in accordance with at least one embodiment. The flowchart 500 is described in conjunction with FIG. 1, FIG. 2, and FIG. 3.

At step 502, one or more scanned answer sheets are received. In an embodiment, the communication manager 212 (refer FIG. 2) receives the one or more scanned answer sheets from the MFD 104. Thereafter, the OCR module 214 recognizes one or more words or characters in each for the one or more scanned answer sheets to determine a first set of answers. The OCR module 214 stores the first set of answers as the answer sheet data 236.

At step 504, the first of answers is compared with a second set of answers to determine one or more correct answers and one or more incorrect answers. In an embodiment, the comparison module 224 compares the first set of answers with the second set of answers.

At step 506, one or more answer descriptors are determined on each of the first set of answers, based on the one or more answer descriptor syntaxes and the first set of answers. In an embodiment, the evaluator module 226 determines the one or more answer descriptors. For example, a student has provided “12” (depicted by 320) as the answer for the question “4+3” (depicted by 310). The evaluator module 226 extracts the one or more answer descriptors syntaxes from the column 308. In an embodiment, the evaluator module 226 executes the logical if-else statements mentioned in column 308 to determine the answer descriptor. “Operator misinterpretation: Answer provided for 4*3 instead of 4+3” (depicted by 336). Similarly, the evaluator module 226 draws an observation for each of the first set of answers.

At step 508, each of the one or more scanned answer sheets is evaluated. In an embodiment, the evaluator module 226 evaluates each of the one or more scanned answer sheets. The evaluator module 226 analyzes the one or more answer descriptors for each of the first set of answers. Thereafter, the evaluator module 226 draws a common conclusion for each of the one or more scanned answer sheets. The evaluator module 226 includes one or more rules to analyze the one or more observations. For example, evaluator module 226 observes that more than 20% of the incorrect questions are due to “operator misinterpretation”. Thus, the evaluator module 226 may draw a conclusion stating, “Student does not read question properly (Attention to detail)”. Further, the evaluator module 226 assigns a grade to each of the one or more scanned answer sheets based on the number one or more correct answers. Additionally, the evaluator module 226 generates a progress report for each of the one or more student based on the common conclusion, and grades.

The profile module 228 updates a student profile for each of the one or more students based on the conclusion drawn on each of the one or more scanned answer sheets.

Thereafter, the communication manager 212 transmits the one or more evaluated answer sheets to the MFD 104. The MFD 104 prints the one or more evaluated answer sheets.

The disclosed methods and systems, as illustrated in the ongoing description or any of its components, may be embodied in the form of a computer system. Typical examples of a computer system include a general-purpose computer, a programmed microprocessor, a micro-controller, a peripheral integrated circuit element, and other devices, or arrangements of devices that are capable of implementing the steps that constitute the method of the disclosure.

The computer system comprises a computer, an input device, a display unit and the Internet. The computer further comprises a microprocessor. The microprocessor is connected to a communication bus. The computer also includes a memory. The memory may be Random Access Memory (RAM) or Read Only Memory (ROM). The computer system further comprises a storage device, which may be a hard-disk drive or a removable storage drive, such as, a floppy-disk drive, optical-disk drive, etc. The storage device may also be a means for loading computer programs or other instructions into the computer system. The computer system also includes a communication unit. The communication unit allows the computer to connect to other databases and the Internet through an Input/output (I/O) interface, allowing the transfer as well as reception of data from other databases. The communication unit may include a modem, an Ethernet card, or other similar devices, which enable the computer system to connect to databases and networks, such as, LAN, MAN, WAN, and the Internet. The computer system facilitates inputs from a user through input device, accessible to the system through an I/O interface.

The computer system executes a set of instructions that are stored in one or more storage elements, in order to process input data. The storage elements may also hold data or other information, as desired. The storage element may be in the form of an information source or a physical memory element present in the processing machine.

The programmable or computer readable instructions may include various commands that instruct the processing machine to perform specific tasks such as, steps that constitute the method of the disclosure. The method and systems described can also be implemented using only software programming or using only hardware or by a varying combination of the two techniques. The disclosure is independent of the programming language and the operating system used in the computers. The instructions for the disclosure can be written in all programming languages including, but not limited to, ‘C’, ‘C++’, ‘Visual C++’ and ‘Visual Basic’. Further, the software may be in the form of a collection of separate programs, a program module containing a larger program or a portion of a program module, as discussed in the ongoing description. The software may also include modular programming in the form of object-oriented programming. The processing of input data by the processing machine may be in response to user commands, results of previous processing, or a request made by another processing machine. The disclosure can also be implemented in all operating systems and platforms including, but not limited to, ‘Unix’, ‘DOS’, ‘Android’, ‘Symbian’, and ‘Linux’.

The programmable instructions can be stored and transmitted on a computer-readable medium. The disclosure can also be embodied in a computer program product comprising a computer-readable medium, or with any product capable of implementing the above methods and systems, or the numerous possible variations thereof.

Various embodiments of the method and system for evaluating electronic document have been disclosed. However, it should be apparent to those skilled in the art that many more modifications, besides those described, are possible without departing from the inventive concepts herein. The embodiments, therefore, are not to be restricted, except in the spirit of the disclosure. Moreover, in interpreting the disclosure, all terms should be understood in the broadest possible manner consistent with the context. In particular, the terms “comprises” and “comprising” should be interpreted as referring to elements, components, or steps, in a non-exclusive manner, indicating that the referenced elements, components, or steps may be present, or utilized, or combined with other elements, components, or steps that are not expressly referenced.

A person having ordinary skills in the art will appreciate that the system, modules, and sub-modules have been illustrated and explained to serve as examples and should not be considered limiting in any manner. It will be further appreciated that the variants of the above disclosed system elements, or modules and other features and functions, or alternatives thereof, may be combined to create many other different systems or applications.

Those skilled in the art will appreciate that any of the aforementioned steps and/or system modules may be suitably replaced, reordered, or removed, and additional steps and/or system modules may be inserted, depending on the needs of a particular application. In addition, the systems of the aforementioned embodiments may be implemented using a wide variety of suitable processes and system modules and is not limited to any particular computer hardware, software, middleware, firmware, microcode, etc.

The claims can encompass embodiments for hardware, software, or a combination thereof.

It will be appreciated that variants of the above disclosed, and other features and functions or alternatives thereof, may be combined into many other different systems or applications. Various presently unforeseen or unanticipated alternatives, modifications, variations, or improvements therein may be subsequently made by those skilled in the art which are also intended to be encompassed by the following claims.

What is claimed is:

1. A computer implemented method for generating an evaluation model, the computer implemented method comprising:
generating a question data set comprising one or more questions;
generating an answer data set comprising one or more answers, wherein the one or more answers correspond to each of the one or more questions;
generating an answer descriptor syntax data set comprising one or more rules to generate one or more answer descriptors, wherein the one or more answer descriptors correspond to one or more observations based on each of the one or more answers;
generating a question descriptor data set describing the one or more questions, wherein the question descriptor data set corresponds to characteristics of one or more elements in the one or more questions; and
generating the evaluation model based, at least in part, on the answer descriptor syntax data set or the question descriptor data set.

2. The computer implemented method of claim 1, wherein the one or more answers comprises one or more correct answers and one or more incorrect answers for each of the one or more questions.

3. The computer implemented method of claim 1 further comprising storing the evaluation model.

4. A computer implemented method for evaluating an electronic document, the computer implemented method comprising:
receiving the electronic document containing a first set of answers corresponding to one or more pre-stored questions;
comparing the first set of answers with a pre-stored second set of answers based on an answer descriptor syntax dataset, wherein the answer descriptor syntax dataset comprises one or more rules;
determining one or more answer descriptors for each of the first set of answers based on the comparing, wherein the one or more answer descriptors correspond to one or more observations for each of the first set of answers; and
evaluating the electronic document based on the determining.

5. The computer implemented method of claim 4, wherein the evaluating comprises generating one or more grades corresponding to the electronic document, wherein the one or more grades are indicative of a number of correct answers corresponding to one or more questions.

6. The computer implemented method of claim 4, wherein the evaluating further comprises generating one or more progress reports based on the comparing and determining.

7. The computer implemented method of claim 6, wherein the one or more progress reports comprises at least one of the one or more pre-stored questions, one or more grades, the one or more answer descriptors, the first set of answers, and the pre-stored second set of answers.

8. The computer implemented method of claim 7 further comprising storing the one or more progress reports.

9. The computer implemented method of claim 4 further comprising generating a question data set comprising the one or more pre-stored questions.

10. The computer implemented method of claim 4 further comprising generating the pre-stored second set of answers, wherein the pre-stored second set of answers correspond to correct answers for each of the one or more pre-stored questions.

11. The computer implemented method of claim 4 further comprising generating an answer descriptor syntax data set comprising one or more rules to generate one or more answer descriptors, wherein the one or more answer descriptors correspond to the one or more observations on the first set of answers.

12. The computer implemented method of claim 4 further comprising generating a question descriptor data set describing the one or more pre-stored questions.

13. A system for generating an evaluation model, the system comprising:
a question data set generation module configured to generate a question data set comprising one or more questions;
an answer data set generation module configured to generate an answer data set comprising one or more answers, wherein the one or more answers correspond to each of the one or more questions;
a descriptor syntax generation module configured to generate an answer descriptor syntax data set comprising one or more rules to generate one or more answer descriptors, wherein the one or more answer descriptors correspond to one or more observations based on each of the one or more answers; and
an evaluator module configured to generate the evaluation model based on the answer descriptor syntax data set.

14. The system of claim 13 further comprising a question descriptor module configured to generate a question descriptor data set describing the one or more questions.

15. The system of claim 14, wherein the question descriptor data set corresponds to characteristics of one or more elements in the one or more questions.

16. The system of claim 15, wherein the one or more answers comprise one or more correct answers and one or more incorrect answers for each of the one or more questions.

17. A system for evaluating an electronic document, the system comprising:
a comparison module configured to compare a first set of answers in the electronic document with a pre-stored second set of answers based on an answer descriptor syntax dataset, wherein the answer descriptor syntax dataset comprises one or more rules;
an evaluator module configured to:
determine, one or more answer descriptors for each of the first set of answers based on the comparing, wherein the one or more answer descriptors correspond to one or more observations for each of the first set of answers; and
evaluate the electronic document based on the one or more answer descriptors.

18. The system of claim 17 further comprising an optical character recognition module configured to recognize one or more characters from the electronic document.

19. The system of claim 17, wherein the evaluator module is further configured to generate one or more grades corresponding to the electronic document, wherein the one or more grades are indicative of a number of correct answers corresponding to one or more questions.

20. The system of claim 17, wherein the evaluator module is further configured to generate one or more progress reports.

21. The system of claim 20, wherein the one or more progress reports comprises at least one of one or more pre-stored questions, one or more grades, the one or more answer descriptors, the first set of answers, and the pre-stored second set of answers.

22. The system of claim 17 further comprising a question data set generation module configured to generate a question data set comprising one or more pre-stored questions.

23. The system of claim 22, wherein the question data set generation module comprises a parsing tool that generates the question descriptor data set describing one or more pre-stored questions.

24. The system of claim 17 further comprising a question descriptor module configured to generate a question descriptor data set describing one or more pre-stored questions.

25. The system of claim 17 further comprising an answer data set generation module configured to generate the pre-stored second set of answers, wherein the pre-stored second set of answers correspond to correct answers for each of one or more pre-stored questions.

26. The system of claim 17 further comprising a descriptor syntax generation module configured to generate an answer descriptor syntax data set comprising one or more rules to generate the one or more answer descriptors, wherein the one or more answer descriptors correspond to the one or more observations based on each of the first set of answers.

27. A computer program product for use with a computer, the computer program product comprising a computer readable program code embodied therein for generating an evaluation model, the computer readable program code comprising:
program instructions means for generating a question data set comprising one or more questions;
program instructions means for generating an answer data set comprising one or more answers, wherein the one or more answers correspond to each of the one or more questions;
program instructions means for generating an answer descriptor syntax data set comprising one or more rules to generate one or more answer descriptors, wherein the one or more answer descriptors correspond to one or more observations based on each of the one or more answers; and
program instructions means for generating the evaluation model based on the one or more answer descriptors.

28. A computer program product for use with a computer, the computer program product comprising a computer readable program code embodied therein for evaluating an electronic document, the computer readable program code comprising:
program instructions means for comparing a first set of answers with a pre-stored second set of answers, wherein the first set of answers corresponds to one or more pre-stored questions contained in the electronic document;
program instructions means for determining one or more answer descriptors for each of the first set of answers based on the comparing, wherein the one or more answer descriptors correspond to one or more observations for each of the first set of answers; and
program instructions means for evaluating the electronic document based on the determining.
